(19) United States
(12) Patent Application Publication
(10) Pub. No.: US 2011/0191259 A1
(43) Pub. Date: Aug. 4, 2011

(54) Financial Document Request and Retrieval

(75) Inventors: William Charles Robinson, Annapolis, MD (US); Stephen R. Giumentaro, Windsor, CT (US)

(73) Assignee: BANK OF AMERICA CORPORATION, Charlotte, NC (US)

(21) Appl. No.: 12/700,166

(22) Filed: Feb. 4, 2010

(51) Int. Cl. G06Q 10/00; G06Q 40/00; G06F 17/30

(52) U.S. Cl. 705/342; 707/812; 707/769; 707/E17.044; 707/E17.014

(57) ABSTRACT

Requests for physical documents matching one or more transaction document images may be processed by a request clearinghouse system. For example, the request clearinghouse system may identify the requested physical document and determine a storage location thereof. Upon identifying the storage location, the request clearinghouse system may add the request to a worklist of the storage location. Each storage location may have its own worklist. Upon completion of a task (e.g., processing of a request), the storage location may transmit a confirmation to the request clearinghouse system. The request clearinghouse system may notify the requesting party that the request was processed. Additionally or alternatively, storage location systems may transmit transaction information to the request clearinghouse system upon detection of a new physical document or transaction. This information may include document images, transaction parties, transaction amounts and the like.

### BACKGROUND

Financial institutions, not unlike many businesses, attempt to cut costs, increase speed and improve efficiency in many aspects of its operations. For example, many transactions are now reviewed and completed by using electronic images of physical transaction documents such as deposit forms, checks, and the like, that can be retrieved and viewed virtually instantly. However, in some instances (such as when an electronic image is of poor quality or an image is missing), the physical document may still be needed.

### SUMMARY

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the description below.

According to one or more aspects, a request clearinghouse system may be used to field and respond to physical document requests. For example, the clearinghouse system may receive a request for a physical document, determine a location where the physical document is stored and retrieve the document. Retrieval of the document may include adding a task to send the physical document to a requesting party onto a worklist. The worklist may be specific to the storage location. In one or more arrangements, the clearinghouse system may further request confirmation that the document was provided to the requesting party, at which time the task may be cleared. The request clearinghouse system may further track requests using an internal worklist to insure that physical document requests are addressed.

According to another aspect, a physical document storage location may be configured to transmit notifications to a central system such as a request clearinghouse system, indicating the addition of new physical documents at that location. A system at the physical document storage location may further field requests for documents and confirm that the request was handled. In one example, the system may generate and print a worklist upon receipt of a new task, each day, hour, 12 hours or the like for processing by personnel at the location. Once a task has been completed, the storage location system may transmit notification of such completion to a central system from which the task was assigned.

### BRIEF DESCRIPTION OF THE DRAWINGS

The present disclosure is illustrated by way of example and not limited in the accompanying figures in which like reference numerals indicate similar elements.

FIG. 1 illustrates an example of a suitable operating environment in which various aspects of the disclosure may be implemented.

FIG. 2 illustrates an example network environment for processing financial transactions according to one or more aspects described herein.

FIG. 3 illustrates a method by which a document request clearinghouse may process requests for physical documents according to one or more aspects described herein.

FIG. 4 illustrates an example user interface through which a user may review transaction information and request a physical document associated therewith.

FIG. 5 illustrates a method that may be performed at a physical document storage location for processing physical document request according to one or more aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized and structural and functional modifications may be made without departing from the scope of the present claimed subject matter.

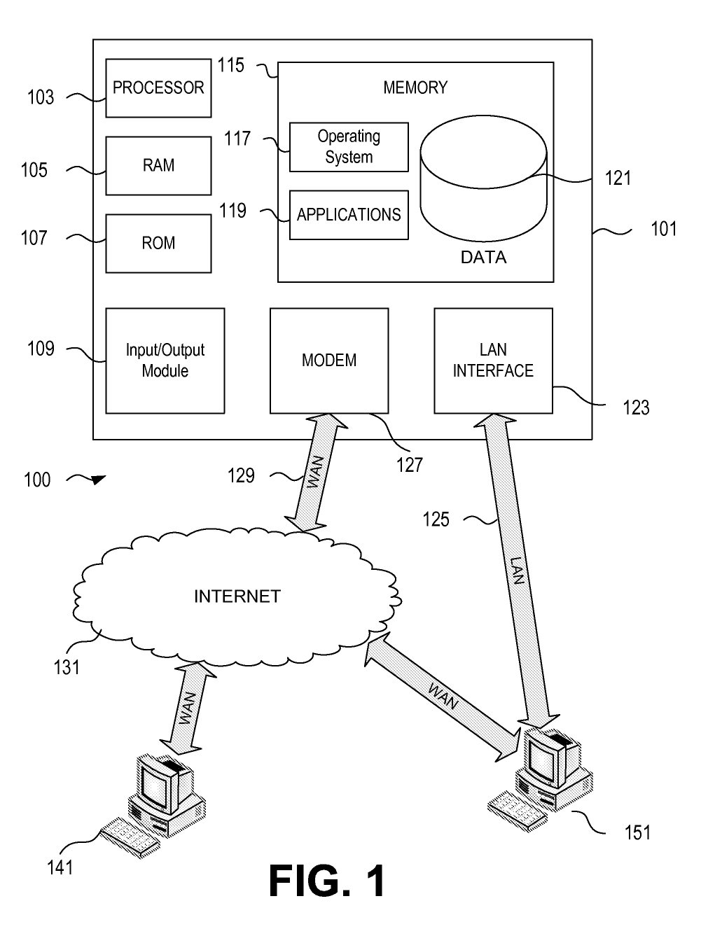

FIG. 1 illustrates a block diagram of a generic computing device 101 (e.g., a computer server) in computing environment 100 that may be used according to an illustrative embodiment of the disclosure. The computer server 101 may have a processor 103 for controlling overall operation of the server and its associated components, including random access memory (RAM) 105, read-only memory (ROM) 107, input/output (I/O) module 109, and memory 115.

I/O 109 may include a microphone, mouse, keypad, touch screen, scanner, optical reader, and/or stylus (or other input device(s)) through which a user of server 101 may provide input, and may also include one or more of a speaker for providing audio output and a video display device for providing textual, audiovisual and/or graphical output. Software may be stored within memory 115 and/or other storage to provide instructions to processor 103 for enabling server 101 to perform various functions. For example, memory 115 may store software used by the server 101, such as an operating system 117, application programs 119, and an associated database 121. Alternatively, some or all of server 101 computer executable instructions may be embodied in hardware or firmware (not shown).

The server 101 may operate in a networked environment supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the computer 101 may be connected to the LAN 125 through a network interface or adapter 123. When used in a WAN networking environment, the server 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Computing device 101 and/or terminals 141 or 151 may also be mobile terminals (e.g., mobile phones, PDAs, notebooks, etc.) including various other components, such as a battery, speaker, and antennas (not shown).

According to one or more aspects, the network environment of FIG. 1 may be used to process requests for physical financial documents. For example, in some environments, transactions may be reviewed using electronic images of physical financial documents such as checks, deposit slips, withdrawal slips and the like. If the physical financial document is required for various including verification of authenticity or transaction information (e.g., check number, transaction amount), personnel may request the physical document corresponding to an electronic image. In one example, an electronic image of a physical document may be of such poor quality that a transaction number or amount cannot be accurately determined. Accordingly, bank personnel may request the physical document for verification.

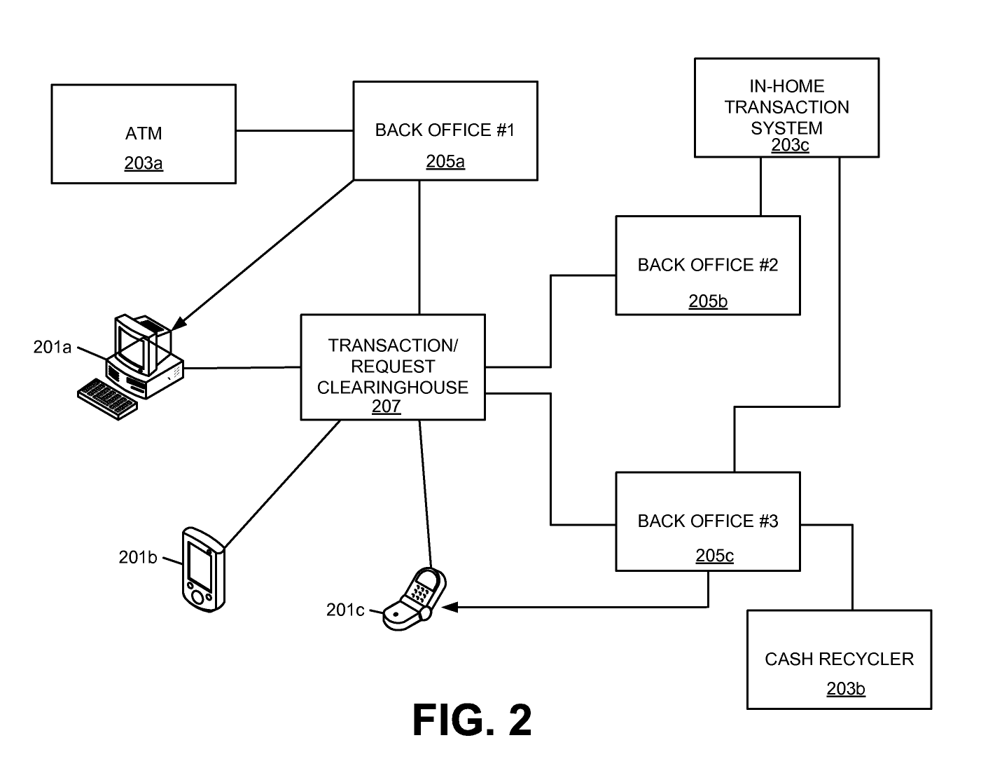

FIG. 2 illustrates an example operating environment including multiple transaction systems that may be used to automatically process physical document requests. Transactions may be performed at a variety of transaction systems including automated teller machines (ATMs) such as ATM 203a, cash recycling devices such as device 203b, in-home transaction devices such as check scanner 203c and the like. Transactions may include withdrawals, deposits, cash checking, transfers, etc. In one or more arrangements, such transactions may involve physical transaction documents such as checks, deposit or withdrawal slips, transfer request forms and/or combinations thereof. While an electronic image of these transaction documents may be initially generated at each of transaction performance systems 203, the physical transaction documents may be sent to one of a plurality of back office systems 205 where the physical documents are stored and managed. In one or more arrangements, back office system 205 may be configured to generate a table or index of the physical documents. For example, the table or index may associate a document number with a transaction number.

The transactions made at systems 203 may be further processed and verified by personnel at a financial institution using devices 201. Devices 201 may be connected through a local area network or wide area network to a transaction clearinghouse 207 configured to manage the electronic images of various transaction documents. Accordingly, users of devices 201 may request and view electronic documentation to perform transaction processing. If, as noted above, the physical document corresponding to a transaction is needed, a user may request the physical document through clearinghouse 207. Clearinghouse 207 may be configured to identify the back office 205a, b or c or other storage location where the requested physical document is stored. The clearinghouse 207 may further insert a task for retrieving the requested physical document into a worklist for the back office (e.g., back office 205b) storing the requested physical document. The worklist may comprise a list of tasks that are to be performed at the corresponding back office. For example, the worklist may be printed at the back office system periodically or aperiodically and the tasks thereon performed by bank employees. Thus, a requested physical document may be retrieved at a back office system and physically sent to the requesting user, for instance, by an employee completing the task on the task list.

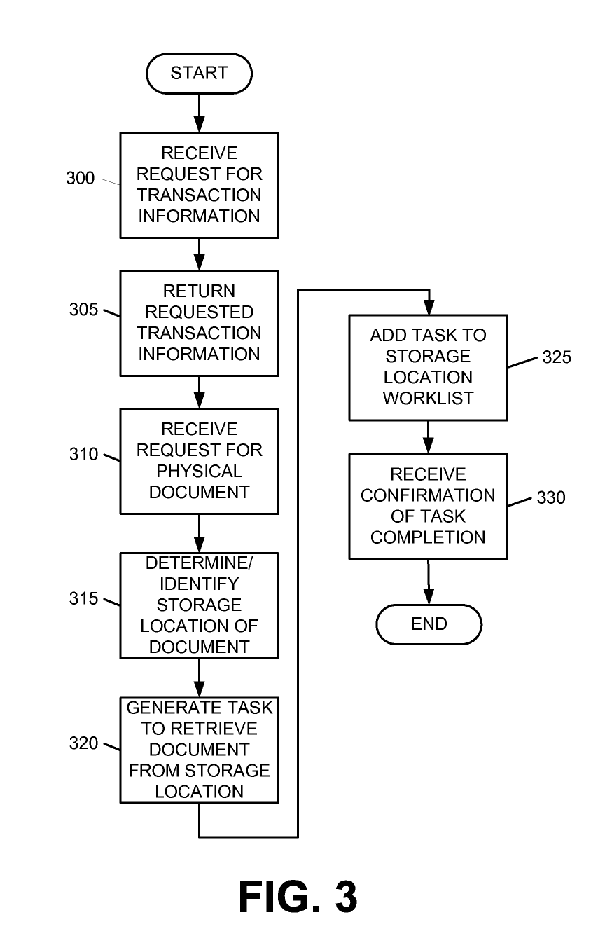

FIG. 3 illustrates a method by which a document request clearinghouse may process requests for physical documents according to one or more aspects described herein. In step 300, the clearinghouse system may receive requests for transaction information. The requests may be made by employees or personnel of a financial institution seeking to review and finalize submitted transactions. The request may be made using a specific transaction identifier, based on search terms such as a transaction party's name or personal information, a financial institution associated with the financial transaction and the like. In response to the requests, the clearinghouse system may return transaction information to the requesting device/user in step 305. The returned data may include images of transaction documents, an electronic transaction record, identification of authorizing parties and the like. The request clearinghouse system may, in one or more arrangements, request approval or other input regarding the transaction for which information was requested. For example, financial institution personnel may be asked to confirm that the transaction information is correct and that the transaction is approved for processing.

In step 310, the request clearinghouse may receive a request for a physical financial document relating to a transaction (e.g., the transaction for which information was requested in step 300). The request may be made based on a specific transaction identifier, a financial document number (e.g., a check number, a deposit slip number), the name or other identifier of a party to the financial transaction and/or combinations thereof. Upon receipt of the request for the physical financial document, the clearinghouse system may determine or identify a storage location where the requested physical financial document is located in step 315. Storage locations may correspond to one or more back offices of locations where the transaction was originally conducted. For example, checks may be held at a bank branch where a depositor made the transaction or where a payee cashed the check. Accordingly, the request clearinghouse system may have visibility and knowledge of multiple back offices or document storage locations (e.g., various bank branches, etc.) for a particular financial institution or organization.

Once the storage location of the requested physical document is determined, the clearinghouse system may generate a task to retrieve the physical document for the requesting party in step 320. The task may then be added to a worklist for the storage location in step 325. The worklist may comprise a list of requests or other tasks that are to be processed by the storage location (e.g., addressed/completed by personnel at a bank branch). In one or more arrangements, the clearinghouse system may subsequently receive confirmation that the task was completed in step 330. The confirmation may be used by the clearinghouse system to clear the pending task from a clearinghouse system master worklist. Alternatively or additionally, if confirmation of task completion is not received, the clearinghouse system may request confirmation from the determined storage location. The clearinghouse system may, for instance, wait a period of 24 hours for confirmation from the storage location indicating that the task was completed (e.g., that the physical document was sent to the requesting party) before inquiring with the storage location.

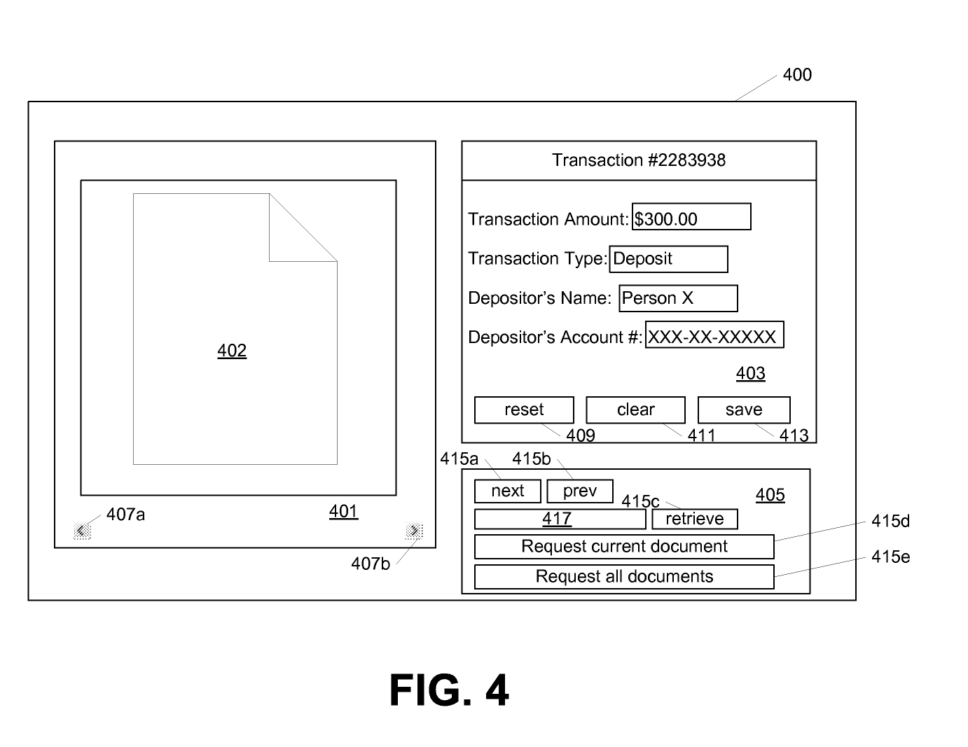

FIG. 4 illustrates a user interface through which a user may review transaction information and request a physical document associated therewith. For example, user interface 400 may include a transaction document review section 401, a transaction information display section 403 and options tool bar 405. Document review section 401 may be configured to display an image 402 of one or more transaction documents such as checks, money transfer forms and/or other financial forms. These images may comprise a scanned in or other electronically capture image of the actual documents used in the transaction. Scroll arrows 407 may be included in section 401 to allow a user to scroll through the various images that are available for the transaction being viewed. Alternatively or additionally, a drop down menu (not shown) may be used to allow user browsing and selection of available transaction document images. Transaction information display section 403 may display additional information relating to the transaction such as transaction amount, transaction identifier, personal information of the parties to the transaction (e.g., name, address, phone number, social security number, etc.). Transaction information display section 403 may provide input fields that allow a user to modify the information currently stored. A reset option 409 may be included in section 403 to allow a user to reset the data to a previously stored state. A clear option 411 may further be used to clear all fields (e.g., erase all stored data from the transaction fields). Save option 413 may also be included to allow a user to save data entered.

Options tool bar 405 may include a plurality of options 415 for controlling the transaction information displayed in sections 401 and 403 and requesting physical documents. For example, Options 415a and 415b may be used to scroll to a previous or subsequent transaction. Alternatively or additionally, a user may enter a particular transaction identifier in field 417 and selecting retrieve option 415c. Tool bar 405 may further include physical document request option 415d that allows a user to request a physical document corresponding to a document image currently displayed in section 401. Another option 415e may be provided to allow a user to request all physical documents corresponding to the currently displayed transaction. In one or more configurations, document request option 415d may be grayed out or displayed in an alternate manner indicating that option 415d is non-selectable if a physical document is not available. Similarly, option 415e may be grayed out or displayed in the alternate manner if no physical documents are available.

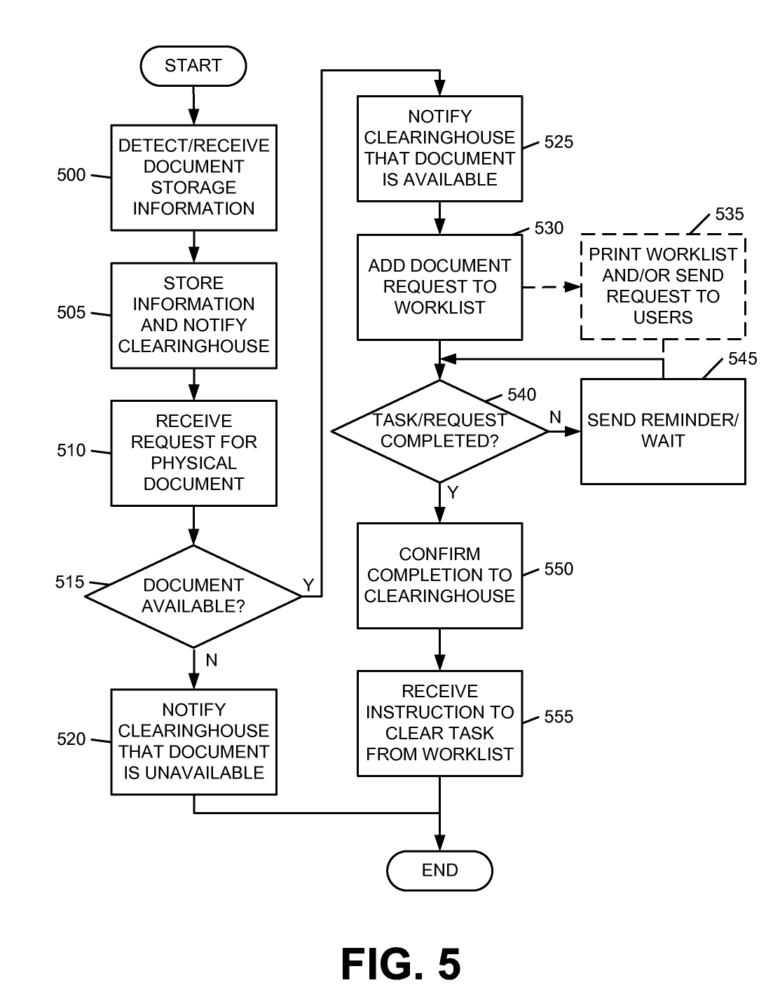

FIG. 5 illustrates a method that may be performed at a physical document storage location for processing physical document requests. In step 500, a system at the document storage location may detect or receive information indicating that a physical document is stored at that location. This information may be manually entered by a user or may be automatically detected using methods such as optical character recognition (OCR), barcode scanning, and the like. In step 505, the system may store the transaction document information and send the information to a remote system such as a request clearinghouse system. The information may be provided to a central system to create a central database of physical document storage locations. The transmission to the remote system may include a type of document, a storage location (e.g., the location's address and a location within the storage location), entry date and/or combinations thereof.

In step 510, the storage location system may receive a request for a physical transaction document from the remote system. The request may identify a transaction document by document number, transaction identifier, payee or payor information and the like. In step 515, the storage location system may determine if the physical transaction document is available. Availability may be determined based on whether the document is still located at the location, whether the document is being used and distribution limits. If the document is not available, the storage location system may notify the remote system of such in step 520. If, however, the document is available, the system may notify the remote system that the document is available in step 525. Furthermore, the storage location system may add the document request to a local worklist in step 530. For example, the storage location system may add an entry to a daily task list that specifies the request for the document. The entry may include a destination for the document and identification of a requesting party. Optionally, the worklist may be automatically printed or sent to one or more users in step 535. The transmission or printing of the worklist may occur based on a predefined schedule or upon entry of a new task on the worklist.

In step 540, the storage location system may determine whether the task has been completed. If not, the storage location system may send a reminder and/or continue to wait in step 545. If, however, the storage location system determines that the task has been completed, the system may notify the remote system that the task has been completed (e.g., that the document has been sent to the intended destination) in step 550. In response, the storage location system may receive an instruction from the remote system to clear the task from the worklist in step 555. The instruction from the remote system may, in one or more arrangements, be received upon the remote system receiving confirmation of receipt of the physical document from a requesting party.

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by one or more computers and/or one or more processors associated with the computers. Generally, program modules include routines, programs, objects, components, data structures, etc. that perform particular tasks or implement particular abstract data types. Aspects of the disclosure may also be practiced in distributed computing environments where tasks are performed by remote processing devices that are linked through a communications network. In a distributed computing environment, program modules may be located in both local and remote computer storage media including memory storage devices.

The methods and features recited herein may further be implemented through any number of computer readable media that are able to store computer readable instructions. Examples of computer readable media that may be used include RAM, ROM, EEPROM, flash memory or other memory technology, CD-ROM, DVD, or other optical disc storage, magnetic cassettes, magnetic tape, magnetic storage and the like.

While illustrative systems and methods described herein embodying various aspects are shown, it will be understood by those skilled in the art that the invention is not limited to these embodiments. Modifications may be made by those skilled in the art, particularly in light of the foregoing teachings. For example, each of the elements of the aforementioned embodiments may be utilized alone or in combination or sub-combination with the elements in the other embodiments. It will also be appreciated and understood that modifications may be made without departing from the true spirit and scope of the present invention. The description is thus to be regarded as illustrative instead of restrictive on the present invention.

We claim:

1. A method comprising:
receiving, at a financial transaction processing system, a request for a physical financial document corresponding to a financial transaction;
determining, by the financial transaction processing system, a storage location of the physical financial document; and
adding the request for the physical financial document to a worklist of the determined storage location, wherein the worklist identifies tasks to be performed at the storage location.

2. The method of claim 1, wherein the request for the physical financial document includes a transaction number of the financial transaction.

3. The method of claim 1, further comprising determining whether the request for the physical financial document is valid.

4. The method of claim 1, wherein adding the request to the worklist includes adding an address of a recipient of the physical financial document.

5. The method of claim 1, wherein the financial transaction processing system stores an electronic image of one or more documents associated with the financial transaction.

6. The method of claim 5, wherein the electronic image includes an image of the physical financial document.

7. The method of claim 1, further comprising receiving confirmation from a system at the storage location indicating that the task was completed.

8. The method of claim 7, further comprising removing the task from a task status list managed by the transaction processing system, the task status list being different from the worklist of the storage location.

9. An apparatus comprising:
a processor; and
memory operatively coupled to the processor and storing computer readable instructions that, when executed, cause the apparatus to:
receive a first request for a first physical financial document corresponding to a financial transaction;
determine a first storage location of the first physical financial document; and
add the request for the first physical financial document to a worklist of the determined first storage location, wherein the worklist identifies tasks to be performed at the first storage location.

10. The apparatus of claim 9, wherein determining the storage location of the physical financial document includes searching a plurality of storage locations for an identifier associated with the physical financial document.

11. The apparatus of claim 9, wherein adding the request for the physical financial document to the worklist includes specifying a destination address for the physical financial document.

12. The apparatus of claim 9, wherein the request is received from a first requesting device and wherein the computer readable instructions, when executed, further cause the apparatus to:
receive a second request for a second physical financial document from a second requesting device different from the first requesting device; and
determine a second storage location of the second physical financial document.

13. The apparatus of claim 9, wherein the computer readable instructions, when executed, further cause the apparatus to receive confirmation from the first storage location that the first physical financial document was sent to a specified requesting party.

14. A method comprising:
detecting, at a computing device, an addition of a physical financial document to a storage location;
transmitting notification of the physical financial document to a document request processing system different from the computing device;
receiving, at the computing device, a request for the physical financial document from the document request processing system; and
automatically adding the request to a worklist for the storage location.

15. The method of claim 14, further comprising:
determining that the request has been addressed; and
in response to determining that the request has been addressed, transmitting a confirmation to the request processing system.

16. The method of claim 15, further comprising receiving a command from the request processing system to clear the request from the worklist in response to the confirmation.

17. The method of claim 14, further comprising:
determining that the requested physical financial document is not available at the storage location; and
in response to determining that the physical financial document is not available at the storage location, notifying the document request processing system of the unavailability of the requested physical financial document.

18. The method of claim 17, wherein determining that the requested physical financial document is not available at the storage location is performed prior to adding the request to the worklist.

19. The method of claim 14, further comprising transmitting transaction information corresponding to the physical financial document to the request processing system, wherein the transaction information includes an electronic image of the physical financial document.

20. The method of claim 14, further comprising receiving a request for confirmation that the request was addressed from the request processing system.
